(19) United States
(12) Patent Application Publication
(10) Pub. No.: US 2013/0118084 A1
(43) Pub. Date: May 16, 2013

(54) WINDOW RESTRICTOR

(71) Applicants: Daniel Arthur Owen, Coventry (GB); Matthew John Watts, Coventry (GB)

(72) Inventors: Daniel Arthur Owen, Coventry (GB); Matthew John Watts, Coventry (GB)

(73) Assignee: Caldwell Hardware (UK) Limited, Coventry (GB)

(21) Appl. No.: 13/463,218

(22) Filed: May 3, 2012

(30) Foreign Application Priority Data
May 4, 2011 (GB) GB1107417.6

(51) Int. Cl. E05D 15/22

(52) U.S. Cl. CPC E05D 15/22
USPC 49/181

(57) ABSTRACT

The invention relates to a device for restricting movement of a sash window relative to a frame, the window comprising: a sash including a pair of stiles, a channel disposed lengthways of one of the stiles; and the frame comprising: a sill, a head spaced from the sill, a pair of jambs and a frame slide track disposed lengthways of one of the jambs; the device comprising: a frame-mounted slide member for slideable engagement with the frame slide track for lengthwise movement relative thereto; a sash slide member for slideable engagement with the channel for lengthwise movement relative thereto; a first arm pivotably connected at one end to the frame-mounted slide member, and pivotably connected at its other end to the sash slide member; and a second arm pivotably connected at its one end to the frame-mounted slide member, and at its other end providing for connection to the sash; such that in use the movement of the window relative to the frame is restricted by the first and second arms.

### CROSS-REFERENCE TO RELATED APPLICATIONS

This patent application claims the priority benefit of Great Britain Application No. 1107417.6 filed May 4, 2012, which is incorporated herein by reference in its entirety.

### BACKGROUND TO THE INVENTION

1. Field of the Invention

The invention relates to a device for restricting movement of a sash window relative to a frame.

It is known to provide a window, or its frame, with one or more restrictors to limit the movement of the window relative to the frame. Window restrictors are commonly applied to windows of multi-storey buildings to prevent the windows being opened beyond a predefined angle, for safety reasons. Restrictors may also be used to support a window when it is open, for the purpose of cleaning the window when it has been opened inwardly so that it inclines into the room.

Windows known as “sliding sash” windows (alternatively vertical sliding windows, single or double hung windows) are those having a pane supported within a ‘sash’ frame, wherein the sash frame and outer window frame are slideably connected so that a part of the window slides relative to the outer frame. When a window is in a closed position, it is held upright within the outer frame. When moved to an open position, a part of the window slides relative to the frame, and the window tilts to a position in which it is inclined to the outer frame. If the window is to be held in an open position, the weight of the window must be supported by the parts connecting the sash window to its frame.

2. Description of Prior Art

Typical window restrictors for sliding sash windows provide an arm at each side of the window, each arm being connected to the outer frame by a sliding connection. The angle through which the window can be opened is determined by the length of the arm, and by the lengths and positions of the channels provided for the sliding connections. However, large windows, double-glazed and triple-glazed windows can be very heavy, and place a large load on the restrictor when the window is held in an open position. This load may cause the restrictor to fail eventually, typically at an end of one of the arms, where a rivet (or an equivalent connection fixture) fails. Alternatively, if the window is ‘dropped’ when being opened, the impact on the rivet as the window reaches its open position may cause the connection fixture to fail instantly. A failure may also occur if one or more of the sliding connections at the end of the arms becomes disengaged from the track it is slideably connected to. This may occur due to the shock of a sudden impact, which may be caused when the window reaches its fully opened position.

While the device of the current invention is particularly suitable for use with a sliding sash window to overcome or reduce the above problems, the device is also suitable for use with any tilting sash window and its use is in no way restricted to use with sliding sash windows.

### SUMMARY OF THE INVENTION

According to a first aspect of the invention, we provide a device for restricting movement of a sash window relative to a frame, the window comprising a sash including a pair of stiles, a channel disposed lengthways of and adjacent or recessed within one of the stiles; and the frame comprising: a sill, a head spaced from the sill, a pair of jambs and a frame slide track disposed lengthways of and adjacent or recessed within one of the jambs; the device comprising a frame-mounted slide member for slideable engagement with the frame slide track for lengthwise movement relative thereto; a sash slide member for slideable engagement with the channel for lengthwise movement relative thereto; a first arm pivotably connected at one end to the frame-mounted slide member, and pivotably connected at its other end to the sash slide member; and a second arm pivotably connected at one end to the frame-mounted slide member, and at its other end providing connection means for connection to the sash; such that in use the movement of the window relative to the frame is restricted by the first and second arms.

According to a second aspect of the invention, we provide a sash window assembly comprising a window comprising a sash including a pair of stiles each including a respective channel disposed lengthways of and adjacent or recessed within the stile; a frame including a sill, a head spaced from the sill, and a pair of jambs each including a respective frame slide track disposed lengthways of and adjacent or recessed within the jamb, such that each of the channels lies adjacent a respective one of the frame slide tracks when the window is in a first position in which the window is supported generally upright within the frame; and a pair of restriction devices, each connecting a frame slide track to a corresponding channel, the devices each including a frame-mounted, slide member for slideable engagement with the frame slide track, for lengthwise movement relative thereto; a sash slide member for slideable engagement with the channel for lengthwise movement relative thereto; a first arm pivotably connected at one end to the frame-mounted slide member, and pivotably connected at its other end to the sash slide member; and a second arm pivotably connected at one end to the frame-mounted slide member, and at its other end providing connection means for connection to the sash; wherein the window is moveable relative to the frame between the first position and a second position in which the window is inclined relative to the frame, wherein movement of the window beyond the second position from the first position is restricted.

Further features of the aspects of the invention are set out in the claims appended hereto.

### BRIEF DESCRIPTION OF DRAWINGS

Embodiments of the invention will now be described by way of example only, with reference to the accompanying figures, of which:

FIG. 1 is a perspective view of a window assembly according to the invention;

FIG. 2 is a side view of a window assembly according to the invention, with a cut-away view of a frame;

FIG. 3 is a perspective view of a device according to the invention;

FIG. 4 is a perspective view of a sash slide member according to the invention;

FIG. 5 is a plan view of the sash slide member of FIG. 4;

FIG. 6 is a side view of the sash slide member of FIG. 4;

FIG. 7 is a plan view of the sash slide member of FIG. 4, shown with its buffer in a compressed configuration;

FIG. 8 is an enlarged plan view of part A of the sash slide member of FIG. 5; and

FIG. 9 is an enlarged plan view of part B of the sash slide member shown in FIG. 8.

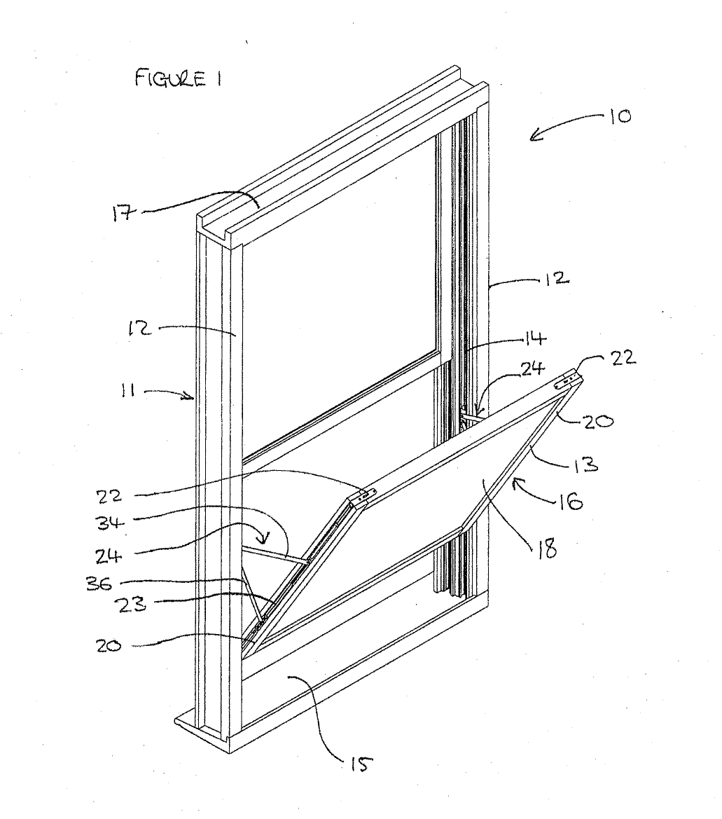

### DESCRIPTION OF PREFERRED EMBODIMENT

With reference to the drawings, there is shown a window assembly 10 including a frame 11 and a window 16. The frame 11 includes a generally horizontal sill 15, a head 17 disposed above the sill and spaced from it, and a pair of upright supports 12, or jambs as they are known in the art, each connecting an end of the sill 15 to a respective end of the head 17.

The window 16 comprises one or more panes 18 of glass supported within a sash 13. The sash 13 comprises a pair of upright stiles 20 disposed on either side of the pane 18, and a pair of rails disposed generally horizontally between the stiles at their respective upper and lower ends, so that the stiles and rails form a rectangular frame around the pane 18.

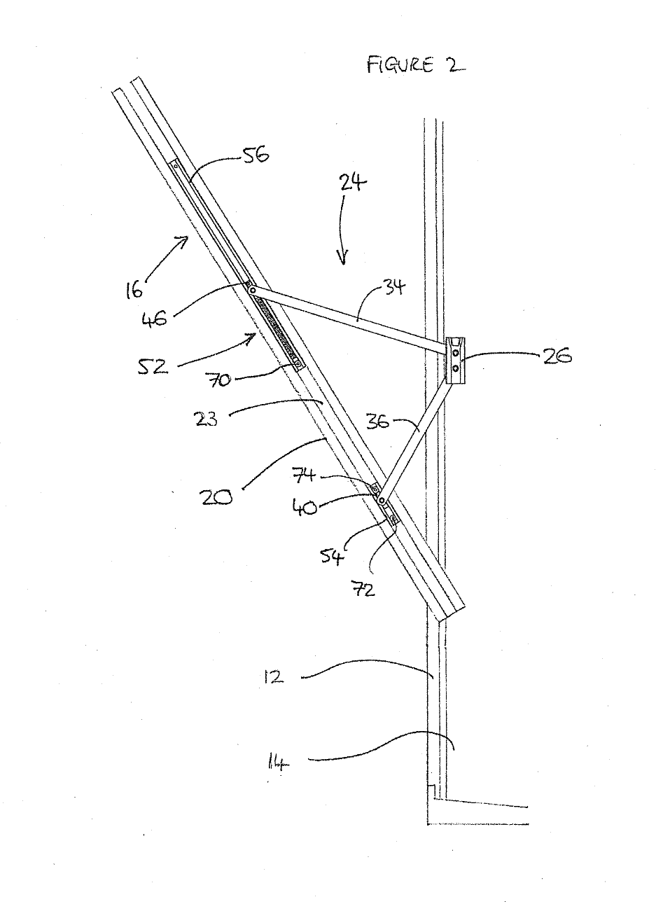

A device 24 for restricting the movement of the window 16 relative to the frame 11 is provided between each side of the window 16 and the corresponding jamb of the frame 11. FIG. 2 shows the device 24 in greater detail, the device 24 being connected to a jamb 12 of the frame, and to one stile 20 of the sash of the window 16. FIG. 3 shows the device 24 in isolation from the window and frame.

The device 24 comprises a frame-mounted slide member 26 which is adapted to engage with a frame slide track 14 that is recessed within one of the jambs 12. The frame slide track 14 is disposed lengthwise of the jamb 12, and provides a track along which the frame-mounted slide member 26 may slide, so as to move lengthwise (upwards and downwards) relative to the jamb 12 of the frame 11. Alternatively, rather than the frame slide track 14 being recessed within the jamb 12, it may be disposed on or adjacent to the jamb 12 so as to lie generally parallel to it. The frame-mounted slide member 26 comprises a body 28 providing connections to first 34 and second 36 arms, and a pair of edge walls 30 adapted for sliding engagement with the sides of the frame slide track 14.

The window 16 includes a guide member, known in the art as a pivot shoe, which extends outwards from the stile 20 of the sash so as to engage with a recess in the jamb 12 (namely the frame slide track 14, in the case where the slide track 14 is provided as a recess within the jamb 12). Typically, the pivot shoe is provided adjacent the lower rail of the sash 13, so that the axis across the width of the lower rail of the sash 13 is held approximately in the plane of the frame 11 as the window 16 slides upwards and downwards relative to the frame 11, and the plane of the window 16 inclines relative to the frame 11. Thus, as the plane of the window 16 is inclined from the vertical, the lowermost edge of the window is held roughly within the plane of the frame 11.

A sash slide member 52 is adapted to engage with a channel 23 in a stile 20 of the window 16. The channel 23 provides a recess in which a sash slide track 56 is disposed, the sash slide track 56 being attached to the channel 23 by attachment means to prevent relative movement between them. The sash slide track 56 provides a track along which the sash slide member 52 may slide, so as to move lengthwise relative to the stile 20 (upwardly or downwardly with respect to the window, when the window is in an upright position). The channel 23 may be an aluminium channel that is formed as a recess into the edge of the stile 20, such that the channel 23 faces the corresponding frame slide track 14 in the corresponding jamb 12 of the frame, which the stile 20 lies adjacent when the window is closed. The channel 23 may be provided with securing means 22 at either end, for securing the channel 23 to the upper and lower rails of the window, or to the edge of the stile 20 itself. Alternatively, the channel 23 may be provided adjacent the stile 20 and disposed generally parallel to it, rather than as a recess within its edge.

The sash slide track 56 comprises a back wall, and lip formations which extend from the back wall so as to overlap a portion of the sash slide member 52, forming a cross-sectional shape that is complementary to the cross-sectional shape of the sash slide member 52, to prevent movement of the sash slide member 52 away from the back wall. The sash slide member 52 engages the sash slide track 56 and is supported relative to it, so that it is slideable lengthwise relative to the sash slide track 56. The attachment means may comprise apertures in the back wall of the sash slide track 56 for receiving screws to connect the sash slide track 56 to the channel 23.

The device 24 further comprises first 34 and second 36 arms which join the part of the device engaged with the frame 11, to the part of the device engaged with the window 16, so that the movement of the window 16 relative to the frame 11 is restricted by the arms. A first arm 34 is pivotably connected at one end to the frame-mounted slide member 26 by a rivet 33, and pivotably connected at its other end to a first end 46 of the sash slide member 52 by another rivet 44. A second arm 36 is pivotably connected by a rivet 32 at one end to the frame-mounted slide member 26, and connected to the sash 13 at its other end. The connection between the second arm 36 and the sash 13 is provided by a connection means, which may comprise a pivoting connection to a part of the stile itself (not shown) by way of a rivet, or may alternatively comprise a further slide member 40 to which the arm is connected pivotally by a rivet 38, the further slide member being slideably engaged with the channel 23 for lengthwise movement relative to the channel.

The further slide member 40 may engage a further sash slide track 54 which is connected to the channel 23 within the stile 20, at a point below (when the window is upright) the sash slide track 56. The further sash slide track 54 may be attached by attachment means to the channel, in a similar manner to the attachment means of the sash slide track 52, and provides a track with which the further slide member 40 is engaged, so as to allow lengthwise movement of the further slide member 40 relative to the further slide track 54.

Stoppers 70, 72, 74 are provided at positions along the channel 23, within the sash slide track 52 and further sash slide track 54. The stoppers 70, 72, 74 may be formed of rubber or a plastics material. The stoppers 70, 72, 74 provide an abutment surface to abut an end of sash slide member 52 or further sash slide member 40, respectively, to prevent further movement in that direction.

A first stopper 70 is disposed at a lower end of the sash slide track 56, so that when a second end 50 of the sash slide member 52 is abutted by the first stopper 70, the second end 50 may move no further in that direction. Second 72 and third 74 stoppers are positioned in the further sash slide track 54, so as to block movement of the further sash slide member 40 in opposite directions, respectively, along the further sash slide track 54 beyond their respective positions.

The sash slide member 52 provides a buffer 48 between the rivet 44 connecting it to the first arm 34 at its first end 46, and the second end 50. This buffer 48 provides cushioning to absorb the force transmitted through the first arm 34 when the window 16 is inclined to its open position, causing the sash slide member 52 to slide downwardly relative to the sash slide track 56 under the weight of the window 16, which in turn causes the second end 50 of the sash slide member 52 to contact the first stopper 70. When the first arm 34 moves further in that direction, the second end 50 can move no further, so the buffer compresses under the force exerted downwardly by the first arm 34. When the reactive force of the compressed buffer 48 matches the downward force exerted by the first arm 34, the window 16 and sash slide member 52 come to rest.

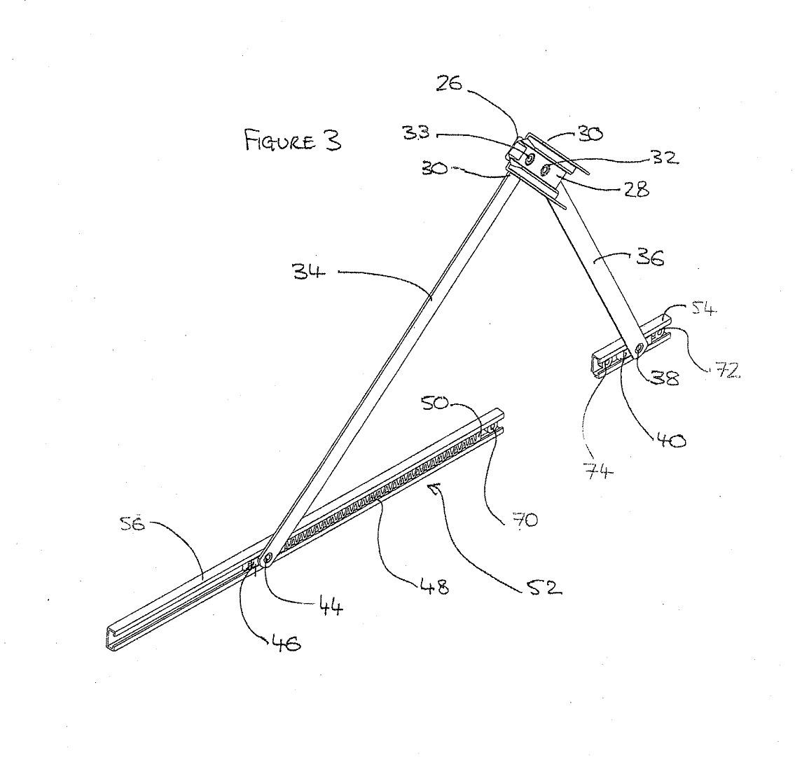

The sash slide member 52 is shown in more detail in FIGS. 4 to 9 of the Drawings. FIGS. 4, 5 and 6 show the sash slide member 52 in its uncompressed configuration, having a first end 46 with a recess for receiving a part connected to the end of the first arm 34 for engagement therewith, and a second end 50. The recess is formed between a pair of end walls 62, 64 and a back surface 66, with which a complementary part of the first arm 34 may engage. The part of the first arm 34 is then held relative to the sash slide member 52 between the end walls 62, 64 of the recess, the back surface 66 of the recess, and the lips of the sash slide track 56. The complementary nature of the fit between the complementary part of the first arm 34, the lips and the recess, means that no additional connecting part or fitting is required to hold the first arm 34 relative to the sash slide member 52.

The buffer 48 is a resilient formation comprising a length of resilient material forming a plurality of wall formations disposed across the width of the buffer, in a zig-zag configuration. The resilient material may comprise polypropylene and Styrene-Ethylene-Butylene-Styrene (SEBS) in a ratio of 3:1.

The cross-sectional shape of the buffer 48 is complementary to that of the sash slide track 56, the buffer 48 having a wider part 60 which lies adjacent the back wall of the sash slide track 56, and a narrow central part 58 that protrudes from the sash slide track 56 between its lips.

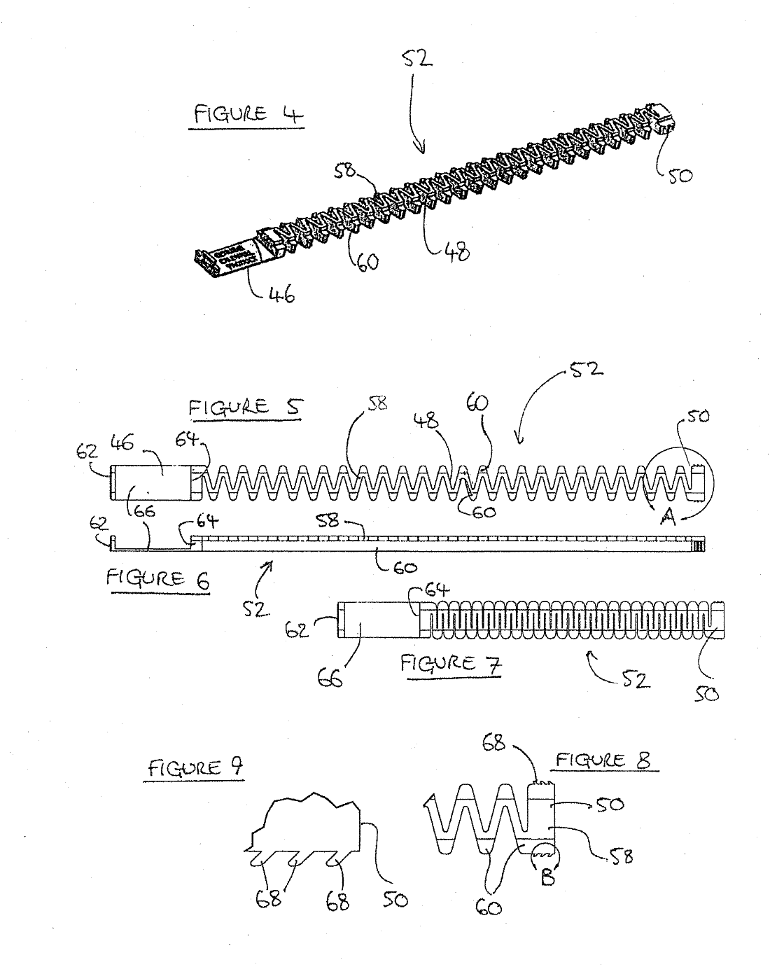

The resilient nature of the buffer 48 allows it to be compressed to a compressed configuration (as shown in FIG. 7) under load, and then to extend to its original configuration once the load is removed. Adjacent wall formations of the buffer 48 define volumes therebetween, wherein compression of the buffer causes the volumes to decrease.

When the buffer 48 is in the compressed configuration, movement of the first arm 34 away from the first stopper 70 causes the first end 46 of the sash slide member 52 to move away from the first stopper 70, allowing the resilient formation to extend to its original configuration such that the buffer is no longer in the compressed configuration.

As shown in FIGS. 8 and 9, the second end 50 of the sash slide member 52 includes an engagement formation 68 which engages the inner walls formed by the lips extending from the back wall of the sash slide track 56. The engagement formation 68 comprises a plurality of projections extending outwardly from both sides of the second end 50 in a direction generally towards the first end 46 of the sash slide member 52.

In use, the window 16 of a sliding sash window assembly 10 is supported in an upright position within the frame 11 in a ‘closed’ position. A pair of devices 24 according to the invention is connected between the window 16 and the frame 11, one on either side of the width of the window. In the closed position, the weight of the window 16 is largely supported by the frame (and via a sash counterbalance mechanism typically installed in the jambs of the frame). The window 16 may be inclined inwardly from this position, up to an angle of 35° to 40°, into an ‘opened’ position. When in its opened position, the weight of the window is no longer supported by the sill 15 to such a large extent, and instead much of the weight bears on the arms 34, 36 of the restrictor devices. The majority of the weight of the window 16 bears on the first arms 34, and the second arms 36 bear a smaller proportion of the weight. The second arms 36 ensure that the outer edges of the sash 13 are held “square” to the frame (in alignment, width-wise relative to the jambs 12), to prevent the window 16 twisting out of position.

When moving the window between its closed and opened positions, the frame-mounted slide member 26 slides upwardly as the window tilts inwardly. As the window inclines towards the horizontal from the vertical, the further sash slide member 40 moves upwardly with the frame-mounted slide member 26, against the third stopper 74 disposed within the further sash slide track 54. The sash slide member 52 moves downwardly towards the first stopper 70. The friction between the edges of the buffer 48 and the walls of the sash slide track 56 causes resistance to the movement of the sash slide member 52, which reduces the speed at which it moves towards the first stopper 70. The sash slide member 52 moves into contact with the first stopper 70, at which point the buffer 48 of the sash slide member 52 compresses under the load of the window 16 transmitted through the first arm 34. The compression of the buffer 48 lessens the force exerted on the connections at either end of the first arm 34 as the sash slide member 52 contacts the first stopper 70, absorbing the impact, and lessening the chance that the device 24 is damaged.

A problem associated with using a resilient buffer 48 of this type, is that the buffer may become compressed and fail to extend to its original configuration. This may occur if the window 16 is supported in the opened position for a long period of time, the compressive force exerted on the buffer 48 may cause the buffer to tend towards its compressed configuration, and fail to extend when the weight of the window 16 is removed. In order to overcome this problem, the buffer 48 is designed so that the engagement formation 68 resists movement in the direction away from the first stopper 70. The projections of the engagement formation 68 are angled away from the first stopper 70, so that movement away from the first stopper 70 causes the points of the projections to engage with the inner walls of the sash slide track 56, creating a relatively large amount of friction. This resistance to movement causes the second end 50 to move more slowly than the first end 46, so that as the first arm 34 moves the first end 40 of the sash slide member 52 away from the first stopper 70, the resilient formation of the buffer 48 extends to its original configuration where it is no longer compressed. This means that when the window is next opened, the buffer 48 will have a greater capacity to cushion the force exerted by the weight of the window than it would have done if the buffer 48 was pre-compressed.

When moved towards the first stopper 70, the engagement formation 68 creates less resistance, relatively, to movement of the second end 50, because the points of the projections are angled away from the direction of movement. As the first arm 34 engages the recess 62, 64, 66 at the first end 46 of the sash slide member 52, upwards movement of the first arm 34 has the effect that the complementary part of the first arm 34 pushes against the end wall 62, causing the sash slide member 52 to move in the direction away from the first stopper 70. The fact that the recess 62, 64, 66 is at the opposite end of the sash slide member 52 to the second end 50, means that the buffer 48 is effectively stretched to its original configuration from its compressed configuration.

The restrictor devices of the current invention have been shown to support windows weighing up to 60 kg in an opened position, and to cushion the impact of a 60 kg window “falling” into an opened position such that no damage occurs. This is in contrast to the 35 kg limit imposed on previously-known single-arm restrictor devices. This improvement allows heavier windows to be used than was previously the case, in situations where restrictors are required, such as in high-rise blocks of offices, for example, where the windows must be inclined inwardly for cleaning. Furthermore, the device of the current invention allows untrained maintenance staff (or homeowners) to tilt windows safely which could previously only be tilted by trained staff due to the weight of the windows.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A device for restricting movement of a sash window relative to a frame, the window comprising: a sash including a pair of stiles, a channel disposed lengthways of one of the stiles; and
the frame comprising: a sill, a head spaced from the sill, a pair of jambs and a frame slide track disposed lengthways of one of the jambs;
the device comprising:
a frame-mounted slide member for slideable engagement with the frame slide track for lengthwise movement relative thereto;
a sash slide member for slideable engagement with the channel for lengthwise movement relative thereto;
a first arm pivotably connected at one end to the frame-mounted slide member, and pivotably connected at its other end to the sash slide member; and
a second arm pivotably connected at its one end to the frame-mounted slide member, and at its other end providing for connection to the sash;
such that in use the movement of the window relative to the frame is restricted by the first and second arms.

2. A device according to claim 1, including a stopper disposed at a position along the length of the channel, such that movement of an end of the sash slide member against the stopper prevents further movement of the sash slide member in that direction.

3. A device according to claim 1, wherein the other end of the second arm comprises a further slide member for slideable engagement with the channel for lengthwise movement relative therewith.

4. A device according to claim 3 including a second stopper disposed at a position along the length of the channel, such that movement of an end of the further slide member against the second stopper limits further movement in that direction.

5. A device according to claim 3 including second and t hird stoppers disposed at positions one each side of the further slide member within the channel such that the movement of the further slide member in a first direction is limited by the second stopper, and movement of the further slide member in a second opposite direction is limited by the third stopper.

6. A device according to claim 1, further comprising a sash slide track for fixed attachment to the channel for preventing relative movement therebetween, the sash slide track having a cross-sectional shape complementary to that of the sash slide member, so as to support the sash slide member relative to the sash slide track while allowing the sash slide member to move lengthwise relative to the sash slide track.

7. A device according to claim 6, wherein contact between the sash slide member and the slide track causes frictional resistance to movement of the sash slide member lengthwise relative to the sash slide track.

8. A device according to claim 2, wherein the sash slide member has a first and a second end, the first arm being connected to the sash slide member at its first end, and the sash slide member having a buffer at its second end, the buffer comprising a resilient formation, and wherein movement of the first arm in first and second directions causes the sash slide member to move towards and away from the stopper, respectively, such that when the first arm moves in the first direction the sash slide member moves towards the stopper until the second end of the sash slide member contacts the stopper preventing further movement of the sash slide member in that direction.

9. A device according to claim 8, wherein, when the second end of the sash slide member is in contact with the stopper, further movement of the first arm in the first direction compresses the buffer to a compressed configuration.

10. A device according to claim 9, wherein when the buffer is in the compressed configuration, movement of the first arm in the second direction away from the stopper causes the first end of the sash slide member to move away from the stopper, allowing the resilient formation to extend to its original configuration.

11. A device according to claim 8, wherein the second end of the sash slide member includes an engagement formation which engages a sash slide track so as to resist movement of the end of the second end of the sash slide member in the second direction, away from the stopper, the sash slide track being attachable to the channel and supporting the sash slide member for movement lengthwise of the sash slide track.

12. A device according to claim 11, wherein the engagement formation comprises a plurality of projections extending from both sides of the second end of the sash slide member in a direction generally towards the first end of the sash slide member, such that the projections resist movement of the second end of the sash slide member relative to the sash slide track in the second direction to a greater extent than relative movement in the first direction.

13. A device according to claim 9 wherein the resilient formation includes a length of resilient material forming a plurality of wall formations disposed across the width of the buffer, such that adjacent wall formations define a volume therebetween, wherein compression of the buffer causes the volumes to decrease.

14. A device according to claim 13 wherein the resilient formation is arranged in a “zig-zag” configuration.

15. A sash window assembly comprising:
a window comprising a sash including a pair of stiles each including a respective channel disposed lengthways of and adjacent or recessed within the stile;
a frame including a sill, a head spaced from the sill, and a pair of jambs each including a respective frame slide track disposed lengthways of and adjacent or recessed within the jamb, such that each of the channels lies adjacent a respective one of the frame slide tracks when the window is in a first position in which the window is supported generally upright within the frame; and
a pair of restriction devices, each connecting a frame slide track to a corresponding channel, the devices each including:
a frame-mounted slide member for slideable engagement with the frame slide track, for lengthwise movement relative thereto;
a sash slide member for slideable engagement with the channel for lengthwise movement relative thereto;
a first arm pivotably connected at one end to the frame-mounted slide member, and pivotably connected at its other end to the sash slide member; and
a second arm pivotably connected at one end to the frame-mounted slide member, and at its other end providing connection means for connection to the sash;
wherein the window is moveable relative to the frame between the first position and a second position in which the window is inclined relative to the frame, wherein movement of the window beyond the second position from the first position is restricted.

16. A window assembly according to claim 15 further including a pair of stoppers, wherein a stopper is disposed at a position along the length of each channel, such that movement of an end of a sash slide member against the stopper prevents further movement of the sash slide member in that direction.

17. A window assembly according to claim 15, wherein each connection means comprises a further slide member for slideable engagement with its respective channel for lengthwise movement relative therewith.

18. A window assembly according to claim 17, wherein each channel further includes a second stopper disposed at a position along its length, such that movement of an end of a further slide member against the second stopper limits further movement in that direction.

19. A window assembly according to claim 17, wherein each channel further includes a second and a third stopper disposed at positions one either side of the further slide member within the channel such that the movement of the further slide member in a first direction is limited by the second stopper, and movement of the further slide member in a second opposite direction is limited by the third stopper.

20. A window assembly according to claim 15, wherein each restriction device further comprises a sash slide track attached to its respective channel for preventing relative movement therebetween, the sash slide track having a cross-sectional shape complementary to that of the sash slide member, so as to support the sash slide member relative to the sash slide track while allowing the sash slide member to move lengthwise relative to the sash slide track.

21. A window assembly according to claim 19 wherein contact between the sash slide member and the slide track causes frictional resistance to movement of the sash slide member lengthwise relative to the sash slide track.

22. A window assembly according to claim 20 wherein each sash slide track comprises a back wall, and lip formations which extend from the back wall so as to overlap a portion of the sash slide member, to prevent movement of the sash slide member away from the back wall.

23. A window assembly according to claim 16, wherein the sash slide member of each restriction device has a first and a second end, the first arm of the respective restriction device being connected to the sash slide member at its first end, and the sash slide member having a buffer at its second end, the buffer comprising a resilient formation, wherein movement of the first arm in first and second directions causes the sash slide member to move towards and away from the stopper, respectively, such that when the first arm moves in the first direction the sash slide member moves towards the stopper until the second end of the sash slide member contacts the stopper preventing further movement of the sash slide member in that direction.

24. A window assembly according to claim 23, wherein when the second end of each sash slide member is in contact with its respective stopper, further movement of the respective first arm in the first direction compresses the buffer to a compressed configuration.

25. A window assembly according to claim 24, wherein when the buffers are in the compressed configuration, movement of the respective first arms in the second direction away from the respective stoppers causes the first end of each sash slide member to move away from the stoppers, allowing the resilient formations to extend to their original configuration such that the buffers are no longer in the compressed configuration.

26. A window assembly according to claim 23, wherein the second end of each sash slide member includes an engagement formation which engages a respective sash slide track attached to its respective channel and supporting the sash slide member for movement lengthwise of the sash slide track, so as to resist movement of the end of the second end of the sash slide member in the second direction, away from its respective stopper.

27. A window assembly according to claim 21 wherein each sash slide track comprises a back wall, and lip formations which extend from the back wall so as to overlap a portion of the sash slide member, to prevent movement of the sash slide member away from the back wall.
